(19) United States
(12) Patent Application Publication
(10) Pub. No.: US 2001/0042431 A1
(43) Pub. Date: Nov. 22, 2001

(54) Cut-to-length shearing device for cropping strips

(76) Inventors: Herbert Epskamp, Meerbusch (DE); Peter de Kock, Oberhausen (DE)

Correspondence Address: FRIEDRICH KUEFFNER, PATENT AND TRADEMARK ATTORNEY, SUITE 1921, 342 MADISON AVENUE, NEW YORK, NY, 10173, US

(21) Appl. No.: 09/821,813

(22) Filed: Mar. 29, 2001

(30) Foreign Application Priority Data
Mar. 31, 2000 (DE) 100 16 209.6

(51) Int. Cl. B26D 1/09

(52) U.S. Cl. 83/694; 83/698.71

(57) ABSTRACT

A cut-to-length shearing device for cropping strips has a stationary lower blade carrying beam having a first lower shearing blade and a stationary upper blade carrying beam having a first upper shearing blade. A mobile blade carrying beam is positioned between the stationary upper and lower blade carrying beams and has a second upper shearing blade and a second lower shearing blade. The second upper shearing blade is complementary to the first upper shearing blade and the first and second upper shearing blades define an upper cutting plane. The second lower shearing blade is complementary to the first lower shearing blade and the first and second lower shearing blades define a lower cutting plane.

### BACKGROUND OF THE INVENTION

1. Field of the Invention

The invention relates to a cut-to-length shearing device for cropping strips, in particular, metal strips, with two cutting planes arranged above one another.

2. Description of the Related Art

In the production of wide strips, sheet metal or the like, it is known to perform a cutting-to-length shearing for cropping the beginning or the end of the strip, in addition to trimming the two strip edges, generally by means of oppositely positioned circular blade shears. In strip manufacturing devices which operate with two coilers on which coils of strip are stored and from which the strip is removed and transported to a further strip treatment location, it is known to provides two cut-to-length shearing units arranged above one another. Accordingly, a complete cropping shears system, each having the same components and drive units, is provided for each strip running plane. Such a cut-to-length shearing arrangement with essentially identical components being provided twice is relatively expensive and complex.

### SUMMARY OF THE INVENTION

It is an object of the present invention to provide a cut-to-length shearing arrangement of the aforementioned kind which requires a reduced expenditure and fewer components.

In accordance with the present invention, this is achieved in that between a stationary lower blade carrying beam and a stationary upper blade carrying beam a mobile blade carrying beam with a lower shearing blade and an upper shearing blade that are complementary to the shearing blades of the stationary blade carrying beams is arranged.

By providing only one mobile blade carrying beam for use in both strip running or cutting planes, the complete blade carrying beam together with guides and drive, which would be required for a second shearing system, can be eliminated.

According to a proposal of the invention, the mobile blade carrying beam is guided on both sides adjacent to the shearing blades and is loaded by force-generating devices which are arranged on the guides at the top and at the bottom. For realizing the guiding action, pillar guides are preferably used on which advantageously force-generating devices in the form of spring assemblies can be arranged. The spring assemblies are supported, on the one hand, on the upper and lower blade carrying beams, respectively, and, on the other hand, on the mobile blade carrying beam. The pillar guides make it possible to carry out a clean cut by bringing together a shearing blade of the movable blade carrying beam and the respectively currently employed complementary upper or lower shearing blade of the stationary blade carrying beams. The force-generating devices, e.g., spring assemblies, ensure that the mobile blade carrying beam is returned after the respective cut into a targeted center position.

For lifting the mobile blade carrying beam, drive devices acting advantageously on the outer sides of the mobile blade carrying beam are provided. The drive devices are preferably hydraulic drive cylinders acting directly on the mobile blade carrying beam or articulated levers which are actuated by drive cylinders.

It is proposed that the mobile blade carrying beam has correlated therewith a synchronizing guide. The synchronizing guide, for example, a synchronizing shaft, ensures synchronized running of the drive devices acting on both ends for lifting or lowering the mobile blade carrying beam.

### BRIEF DESCRIPTION OF THE DRAWING

In the drawing:

FIG. 1 is a schematic front view of a cut-to-length shearing device with two strip running and cutting planes arranged above one another; and

FIG. 2 shows a detail of the shearing device according to FIG. 1 in a schematic front view showing the mobile blade carrying beam arranged between the stationary upper and lower blade carrying beams with an embodiment of the drive unit that differs from that in FIG. 1.

### DESCRIPTION OF THE PREFERRED EMBODIMENTS

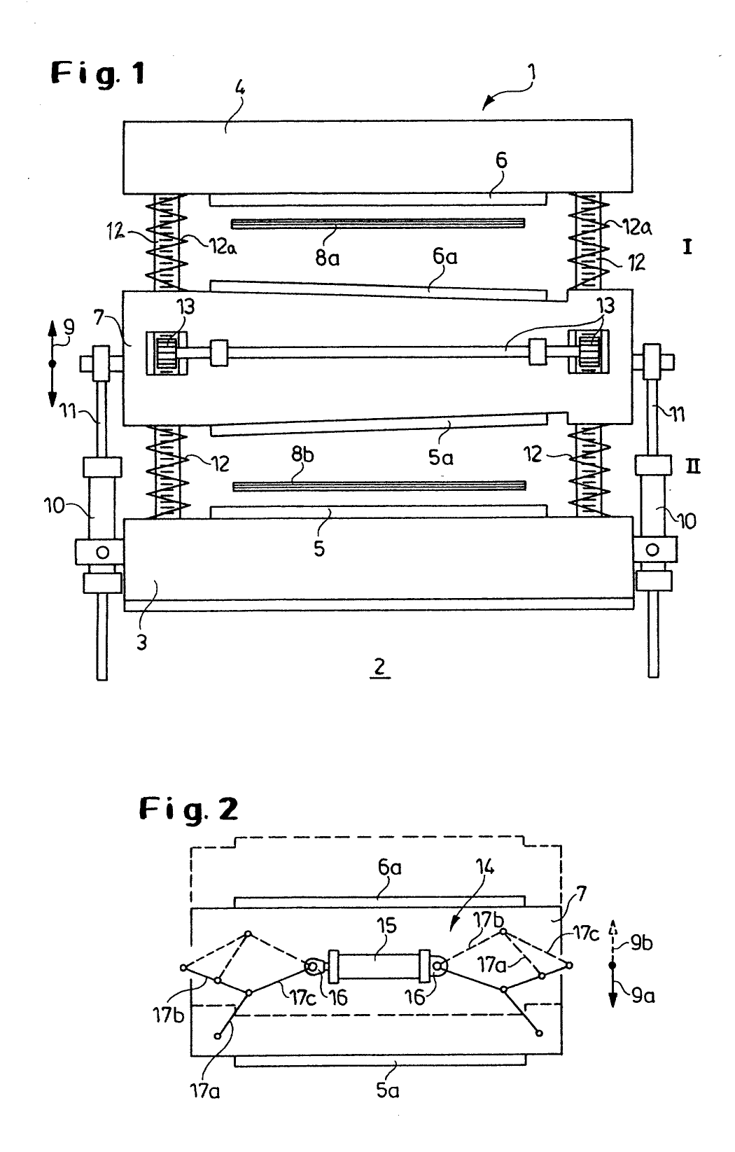

A cut-to-length shearing device 1 illustrated in FIG. 1 has a stationary lower blade carrying beam 3 fastened to the foundation 2 and a stationary upper blade carrying beam 4. The beams 3, 4 are each provided with a shearing blade 5, 6, respectively. The lower blade carrying beam 3 is connected with the upper blade carrying beam 4 by pillars 12 which are provided at the same time for receiving and guiding the mobile blade carrying beam 7 arranged between the stationary lower and upper blade carrying beams 3, 4. The beam 7 has lower and upper shearing blades 5a, 6a which are complementary to the respective shearing blades 5, 6 of the stationary blade carrying beams 3, 4.

The cut-to-length shearing device 1 thus provides two cutting planes I and II for a coiler arrangement (not illustrated), from which the strips 8a, 8b are removed. The removed strips 8a, 8b are thus guided in the strip running plane coinciding with the cutting planes I and II though the cut-to-length shearing device 1 for cropping the beginning and end of the strips.

For cutting the strip 8a running through the upper plane I, the mobile blade carrying beam 7 is lifted so that the shearing blades 6a and 6 together perform the cut. The cropping or transverse cutting of the strip 8b running in the lower plane II is performed by lowering the mobile blade carrying beam 7 so that the shearing blades 5a and 5 complementary to one another can perform the cut. The oppositely oriented lifting/lowering movement of the mobile blade carrying beam 7 is illustrated by arrow 9.

In the illustrated embodiment according to FIG. 1, the two outer sides or ends of the blade carrying beam 7 are engaged by hydraulic drive cylinders 10 provided as drive devices for performing the cut, i.e., for lifting or lowering the mobile blade carrying beam 7. The cylinders 10 are connected via their piston rods 11 to the blade carrying beam 7 and can be controlled so as to act in opposite directions. The mobile blade carrying beam 7 is loaded from above as well as from below by force-generating devices which are embodied as spring assemblies 12a and arranged on the pillar guides 12. They ensure that the mobile blade carrying beam 7, after having performed a cut, is returned into its central or initial position, illustrated in FIG. 1, between the upper and the lower blade carrying beams 3, 4. A synchronizing guide 13 ensures that the mobile blade carrying beam 7 is lifted or lowered without canting when being moved and when performing the cut.

FIG. 2 shows a detailed view of the blade carrying beam 7 with an alternative drive device 14. A centrally arranged cylinder 15 at the center of the beam 7 is provided with articulated levers 17a, b, c connected with one end to the cylinder eyes 16 and with the other end to the mobile blade carrying beam 7. Depending on the direction of loading of the cylinder 15, the mobile blade carrying beam 7 is lowered, as illustrated in FIG. 2 by the solid line representation of the articulated levers 17a, b, c and the directional arrow 9a. The opposite loading of the cylinder 15 results in the movement of the articulated levers 17a, b, c into the lifted position shown by the direction arrow 9b and the blade carrying beam 7 illustrated in dashed lines. In this embodiment a synchronizing guide is not required.

In any case, by means of the mobile blade carrying beam it is now possible that a cropping or transverse cutting can be performed alternatingly in the upper or lower cutting plane I, II without this requiring two separate cut-to-length shearing units.

While specific embodiments of the invention have been shown and described in detail to illustrate the inventive principles, it will be understood that the invention may be embodied otherwise without departing from such principles.

What is claimed is:

1. A cut-to-length shearing device for cropping strips, the shearing device comprising:
a stationary lower blade carrying beam having a first lower shearing blade and a stationary upper blade carrying beam having a first upper shearing blade;
a mobile blade carrying beam positioned between the stationary lower and upper blade carrying beams and having a second upper shearing blade and a second lower shearing blade;
wherein the second upper shearing blade is complementary to the first upper shearing blade and wherein the first and second upper shearing blades define an upper cutting plane; and
wherein the second lower shearing blade is complementary to the first lower shearing blade and wherein the first and second lower shearing blades define a lower cutting plane.

2. The shearing device according to claim 1, further comprising guides and force-generating devices connected to the guides, wherein the mobile blade carrying beam has ends projecting laterally past the second upper and lower shearing blades and the ends are moveably mounted on the guides, wherein the force-generating devices are arranged above and below the mobile blade carrying beam and configured to load the mobile blade carrying beam from above and from below.

3. The shearing device to claim 2, wherein the guides are pillar guides and wherein the force-generating devices are spring assemblies, wherein a first set of the spring assemblies is supported on the upper blade carrying beam and the mobile blade carrying beam and wherein a second set of the spring assemblies is supported on the mobile blade carrying beam and the lower blade carrying beam.

4. The shearing device according to claim 1, further comprising drive devices connected externally to the mobile blade carrying beam.

5. The shearing device according to claim 4, wherein the drive devices are hydraulic drive cylinders.

6. The shearing device according to claim 4, wherein the drive devices are comprised of articulated levers and drive cylinders acting on the articulated levers.

7. The shearing device according to claim 1, further comprising a synchronizing guide arranged on the mobile blade carrying beam.
